(19) United States
(12) Patent Application Publication
(10) Pub. No.: US 2011/0254932 A1
(43) Pub. Date: Oct. 20, 2011

(54) 3D DISPLAY USING PARTIAL SCREEN ILLUMINATION AND SYNCHRONIZED SHUTTER GLASS

(75) Inventor: Cheen-Pow Doung, Cupertino, CA (US)

(73) Assignee: ZORAN CORPORATION, Sunnyvale, CA (US)

(21) Appl. No.: 12/917,976

(22) Filed: Nov. 2, 2010

Related U.S. Application Data
(60) Provisional application No. 61/325,694, filed on Apr. 19, 2010.

(51) Int. Cl. H04N 13/04

(52) U.S. Cl. 348/56; 348/51; 348/E13.026; 348/E13.059

(57) ABSTRACT

An electronic visual display system includes a display screen for displaying an image. The display screen has at least a first display region and at least a second display region that is approximately contiguous to the first display region. The image has at least a first portion that is displayed within the first display region and at least a second portion that is displayed within the second display region. The system further includes a first light source configured to illuminate substantially the first display region, a second light source configured to illuminate substantially the second display region, and a display device controller coupled to the first light source and the second light source which is configured to lessen an amount of light emanating from the first light source approximately when updating the first portion of the image.

### CROSS-REFERENCE TO RELATED APPLICATIONS

This application claims priority under 35 U.S.C. §119(e) to U.S. Provisional Application Ser. No. 61/325,694 entitled “3D Display Using Alternate Half Screen Flashing and Synchronized Shutter Glass,” filed Apr. 19, 2010, which is incorporated herein by reference in its entirety.

### BACKGROUND OF THE INVENTION

Embodiments of the present invention relate generally to stereoscopic imaging, and more specifically, to stereoscopic video displays for use in conjunction with specialized eyewear.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a schematic diagram of an exemplary display system in accordance with one embodiment of the present invention;

FIG. 2A is a front elevation view of an exemplary display system in accordance with another embodiment of the present invention;

FIG. 2B is a side elevation view of an exemplary display system in accordance with another embodiment of the present invention;

FIG. 3 is a timing diagram of an exemplary display system in accordance with yet another embodiment of the present invention; and

FIG. 4 is a flow diagram of an exemplary method in accordance with another embodiment of the present invention.

### DETAILED DESCRIPTION OF THE INVENTION

Embodiments of the present invention are not limited in their application to the details of construction and the arrangement of components set forth in the following description or illustrated in the drawings. Embodiments of the present invention are capable of other embodiments and of being practiced or of being carried out in various ways. Also, the phraseology and terminology used herein is for the purpose of description and should not be regarded as limiting. The use of “including,” “comprising,” “having,” “containing,” “involving,” and variations thereof herein is meant to encompass the items listed thereafter and equivalents thereof as well as additional items.

Stereoscopic (three-dimensional or “3D”) images are produced in pairs, each image of the pair representing a scene presented at slightly different angles that correspond to the angles of vision of each human eye. For displaying stereoscopic images, various techniques involving simultaneous or synchronous projection of left and right field of view images have been developed. In one technique, different images, one for each field of view, are rapidly displayed in alternating succession in conjunction with specialized eyewear to be worn by a viewer. The eyewear may be active eyewear having, for example, LCD shutter lenses. The eyewear is coupled to the television system, and each lens is alternately switched between clear (e.g., “open”) and opaque (e.g., “closed”) in synchronization with the frames of a movie, video, or other 3D image that is displayed using the alternating field of view technique. Accordingly, the left lens is open and the right lens is closed while a left eye field of view image is displayed, and the right lens is open and the left lens is closed while a right eye field of view image is displayed. This permits the displayed image to be seen by only one eye at a time.

Embodiments of the present invention are generally directed to systems and methods for displaying and viewing stereoscopic images with active eyewear. With the advent of home theater systems, it is appreciated that consumers may enjoy viewing 3D movies using television systems adapted for such use. According to various embodiments of the invention, liquid crystal display (LCD) televisions, for example, are one popular type of television that may be so adapted. As used herein, “LCD” refers to the underlying screen of a display, for example, thin film transistor LCD (TFT-LCD). It should be understood, however, that various embodiments of the present disclosure may be implemented on other types of transmissive or emissive displays, including, but not limited to, TFT-LCD, Organic Light Emitting Diode (OLED), devices incorporating certain microelectromechanical systems (MEMS), plasma display panels (PDP), and the like.

According to one aspect of the present invention, a series of stereoscopic images are presented on a television display in a field sequential manner. One field provides the viewing perspective of the left eye, and another field provides the perspective of the right eye. For instance, successive frames of the image series may comprise alternating left and right fields of view for generating an illusion of depth in conjunction with specialized eyewear, such as the shutter lenses described above. A viewer wears the eyewear which alternately transmits and blocks light going to each eye. Each displayed image is steered to the correct eye by synchronizing the eyewear lenses with the display. For example, when a left field of view image is displayed, the left lens is unblocked and the right lens is blocked to steer the displayed image to the viewer's left eye only. Furthermore, when a right field of view image is displayed, the right lens is unblocked and the left lens is blocked to steer the displayed image to the viewer's right eye only.

According to various embodiments, a television using progressive or non-interlaced scanning is configured for displaying 3D programs and movies. Such a television includes a display having a plurality of picture elements (also referred to herein as pixels) that are sequentially updated, for example, in a raster or other sequential scanning pattern, such as row-by-row beginning at the top-left corner of the display and ending at the bottom-right corner. In a progressive scan television, an update of the entire image (or field of view) occurs over a non-zero time interval (e.g., about 8 ms for a 120 Hz LCD TV) because each pixel of the display is updated sequentially, rather than simultaneously. As a result, at certain times during the course of an image update, one region of the TV screen may display a portion of the previous image while the other, most recently updated region, simultaneously displays a portion of the current image. This causes crosstalk between the left and right eyes when using an alternate-frame display sequence because the viewer may simultaneously observe portions of both the left and right fields of view with the same eye. These visual artifacts are disconcerting to the viewer, and also detract from the 3D effect.

One technique for reducing the effect caused by the artifacts includes only opening the shutter lens during a blanking (e.g., non-update) interval that occurs between each full-frame update so that the viewer does not see a partially updated image. The blanking interval may be, for example, as long as the scan time, or full-frame update time, of the display, or less. In an alternate technique, a television light source is dimmed, lessened or extinguished (e.g., the light level is decreased or reduced) during the update scan to obscure the artifacts from the viewer, and the display is illuminated only during the blanking interval. These techniques may cause undesirable flickering and/or may reduce the effective brightness of the display, particularly in a display having a 120 Hz update rate, because the viewer is only able to see the image for a brief period of time after each update is completed. The flickering may be reduced and/or the brightness increased by increasing the rate at which the display is updated, for example, to 240 Hz or greater. However, televisions with faster update rates are more expensive to produce.

According to one embodiment of the invention, an electronic visual display system for displaying stereoscopic images includes a display screen for displaying an image. In one non-limiting example, the display screen may be sequentially updatable. The display screen is partitioned into at least two contiguous regions having substantially equal areas. For instance, a television screen may be divided into a top half (e.g., a first region) and a bottom half (e.g., a second region). It will be understood that regions of differing locations and areas may be used according to a particular application (e.g., a left half and a right half, or a top third, middle third, and bottom third, etc.). Each region is separately and independently illuminated by one or more light sources. For example, the first region may be illuminated by a first light source and the second region may be illuminated by a second light source. Alternatively, a single light source may be configured to illuminate the first region and the second region separately, using, for example, light shutters or other light blocking devices. In certain embodiments, light guides may be used to transmit the light emanating from the single light source or from each light source to a respective region of the display. Optionally, an opaque light barrier may be positioned between each of the light guides to inhibit light leakage from one region of the display to another.

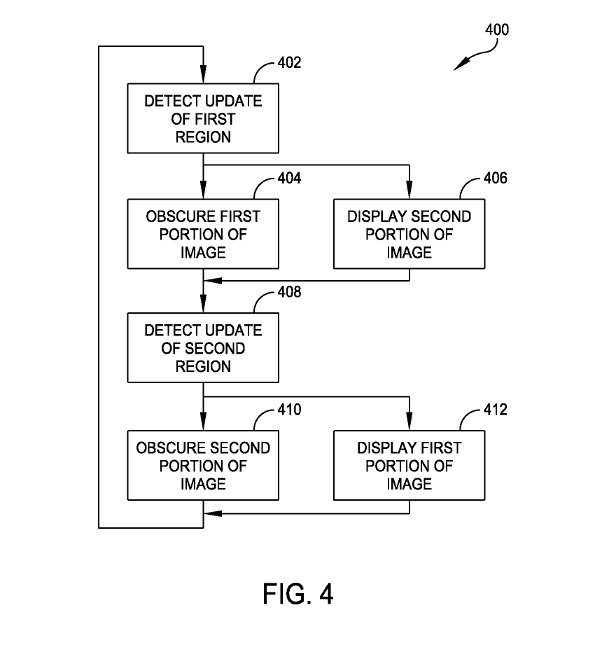

According to another embodiment, the illumination of each region of the display is controlled with respect to an update of an image on the display. In an exemplary display, the image is updated, or scanned, across the display from top to bottom in, for example, a raster pattern, although other sequential scanning patterns may be used. Accordingly, the top half (or first region) of the display is updated first. As the top half of the display is updating, the corresponding light source is dimmed or lessened so as to obscure any portion of the image within this region from view, in particular, to reduce or eliminate visual artifacts, as discussed above. After the top half of the display has been updated, the top half is illuminated, making the top half of the image visible to the viewer. The bottom half (or second region) of the display is updated next, and the light source corresponding to this region of the display is dimmed or lessened to obscure any portion of the image within this region from view. After the bottom half of the display has been updated, the bottom half is illuminated, displaying the bottom half of the image to the viewer. There may be, optionally, a blanking interval between the completion of one update and the beginning of the next update during which no update occurs. During the blanking interval, either or both regions of the display may be illuminated for at least a portion of the blanking interval. The above sequence is repeated as each successive image in the series is updated on the display. An exemplary timing sequence for illuminating the display is illustrated in FIG. 4, which is described in further detail below.

According to yet another embodiment, where a 3D movie or video or other type of 3D image is being displayed, each displayed image contains either a left eye field of view or a right eye field of view. The display system is coupled to eyewear having two independently controllable shutter lenses, such as described above. Each of the lenses is controlled in synchronization with the displayed image to ensure that it is steered to the correct eye of the viewer for producing the 3D effect. Accordingly, the left shutter lens is open (or unblocked) and the right shutter lens is closed (or blocked) when a left eye field of view is displayed, and the right shutter lens is open and the left shutter lens is closed when a right eye field of view is displayed. FIG. 4, described below, also includes an exemplary shutter lens timing sequence.

In another embodiment, the illumination control sequence and shutter lens control sequence described above are used in combination. When a left eye field of view is displayed by either or both halves of the display, the eyewear permits the viewer to see the image with her left eye only, and similarly the eyewear permits the viewer to see the image with her right eye only when a right eye field of view is displayed by either or both halves of the display. Further, when an update is occurring in the top half of the display, that region is dimmed, or the light level lessened, to obscure the corresponding portion of the image from view, and similarly when an update is occurring in the bottom half, that region is dimmed If no update is occurring, the corresponding region may be illuminated for at least a period of time as necessary to display the image with sufficient brightness, which may be less than the total amount of time that the image is actually present on the display.

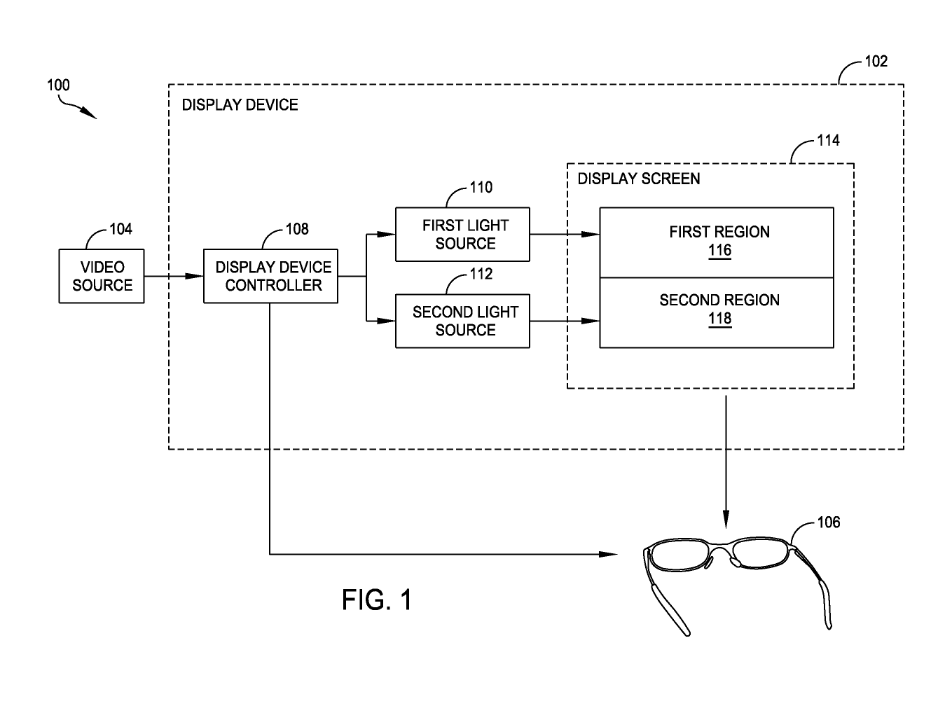

Referring to FIG. 1, a system 100 for viewing stereoscopic images in accordance with one embodiment includes a display device 102, a video source 104 that provides images to be displayed by the display device, and eyewear 106 to be worn by a viewer while viewing the display device. In some embodiments, display device 102 is based at least in part on a progressive scan television, although the display device may also include additional or alternative components depending on the application. Display device 102 includes a display device controller 108 coupled to a first light source 110 and a second light source 112, each of which provides, respectively, illumination for a first region 116 and a second region 118 of a display screen 114. Light from first light source 110 and second light source 112 may provide light, for example, through separate light guides, or through a single light guide having separate light shutters for controlling the provision of light to the respective region of display screen 114. First light source 110 and second light source 112 may be a single light source, or separate light sources. Display screen 114 includes a plurality of picture elements, each adapted to display a portion of an image and each underlying either first region 116 or second region 118 of the display screen. First light source 110 and second light source 112 may be, for example, edge-light units or backlight units that illuminate substantially the corresponding region of display screen 114. Control of each of first light source 110 and second light source 112 may be performed by, for example, display device controller 108, or other light source controller. Light emanating from display screen 114 may be perceived by one or both eyes of the viewer through eyewear 106.

According to one embodiment, display device controller 108 receives a video signal from video source 104. The video signal may include 2D and/or 3D images, and frame synchronization information. Display device controller 108 uses the video signal to update each of the picture elements of display screen 114. Display device controller 108 may also use the synchronization information to synchronize the illumination provided by first light source 110 and second light source 112 with an update scan of display screen 114 such that each region is illuminated when no update is occurring in the corresponding region, and each region is dimmed, or the light level lessened, when an update is occurring in the corresponding region. Display device controller 108 may further use the synchronization information to synchronize the operation of each shutter lens of eyewear 106 with the image (or portion of each image) of the video displayed by display screen 114, such that the image or portion of the image is steered by the eyewear to the correct eye of the viewer.

In another embodiment, eyewear 106 includes a left shutter lens and a right shutter lens. Each shutter lens is independently switched between a transparent state and an opaque state, for example, using a liquid crystal material, by applying a voltage to the respective shutter lens. Eyewear 106 is configured to receive synchronization information and, using the synchronization information, further configured to operate each of the left and right shutter lenses of the eyewear substantially in synchronization with each image (or portion of each image) to be displayed by display device 102. For example, at least one lens of eyewear 106 (e.g., left, right, or both) may be configured to block light in response to receiving the synchronization information. The synchronization information may include a signal that is provided by, for example, display device 102. The signal may be provided to eyewear 106 using any wired or wireless communication channel, interface, and/or protocol, for example, using an infrared (IR) sensor to receive an IR signal. The signal may be used by eyewear 106 to close the left shutter lens, the right lens, or both lenses.

According to one embodiment, display screen 114 is a sequentially addressable display screen, for example, a thin film transistor liquid crystal display (TFT LCD), an organic light emitting diode (OLED), other microelectromechanical systems (MEMS) devices, or a plasma display panel (PDP). It should be understood that the invention may also be implemented in other types of emissive displays. Display screen 114 includes a plurality of picture elements (also referred to herein as pixels), which may be divided in to multiple sub-pixels, for example, one for producing each of red, green, and blue light. The display screen 114 may be updated sequentially at, for example, 120 Hz, 240 Hz, or other rate which is fast enough such that each scan of the entire screen is undetectable to the human eye under normal viewing conditions.

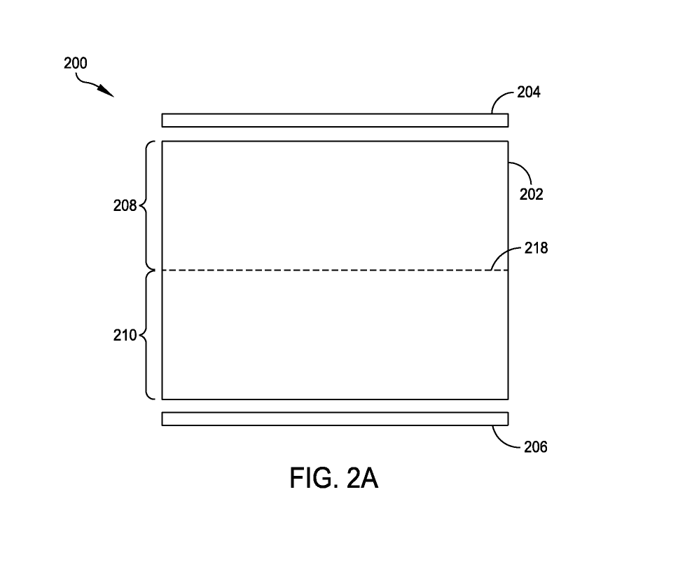

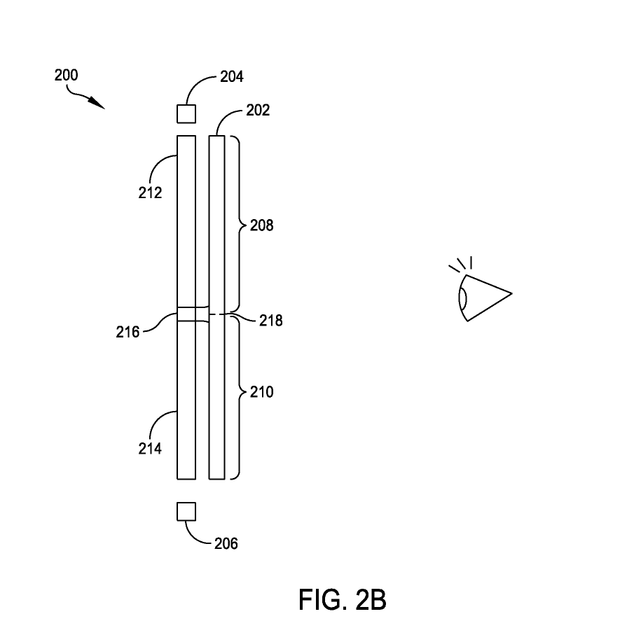

Referring to FIGS. 2A and 2B, a system 200 for viewing stereoscopic images in accordance with one embodiment includes a display screen 202, a first light source 204 and a second light source 206. According to some embodiments, system 200 includes an LCD display or other sequentially updatable, electronically modulated optical device that forms part of a television, computer, or other display device adapted to display images that, in conjunction with specialized eyewear, produces a stereoscopic effect for a viewer. Display screen 202 may be partitioned into, for example, a first region 208 and a second region 210, each contiguous with one another and having substantially equal areas. For instance, first region 208 may include the top half of display screen 202, and second region 210 may include the bottom half, as indicated in FIGS. 2A and 2B.

In one embodiment, display screen 202 includes a plurality of sequentially addressable picture elements (not shown) and may be controlled, for example, by a display device controller (also not shown), such as display device controller 108 described above with reference to FIG. 1. Each picture element of the display screen 202 is sequentially updated from left to right across each row of picture elements, and from top to bottom, one row at a time. It should be appreciated that the present invention may be implemented in devices having alternative update patterns, such as right-to-left, bottom-to-top, and other sequences, and that the disclosed update patterns are intended to be non-limiting examples used in various embodiments.

According to one embodiment, system 200 is configured such that light emanating from first light source 204 and second light source 206 propagates through the picture elements of display screen 202, and outwards towards the viewer. First light source 204 is configured to illuminate substantially all of first region 208 of display screen 202, and second light source 206 is configured to illuminate substantially all of second region 210. When first light source 204 or second light source 206 is turned off, dimmed, blocked, shuttered, decreased, or extinguished, the image displayed in the corresponding region of display screen 202 may become dim or obscured from view. First light source 204 and second light source 206 may each include one or more florescent lamps, one or more light emitting diodes (LEDs), such as white phosphor based LEDs, red-green-blue (RGB) LEDs, organic LEDs (OLEDs), or other electronic light sources. In one embodiment, as illustrated in FIGS. 2A and 2B, first light source 204 and second light source 206 are arranged in an indirect, edge-lit configuration, where the light sources may be positioned above, to the side of, below, or behind display screen 202 with respect to a viewer of the light emanating from system 200. It should be appreciated that rather than using an edge-lit configuration, the first light source and the second light source may be configured in a back-lit configuration. In such a configuration, the first light source and the second light source may each include a plurality of LEDs arranged in a direct back-lit configuration and configured to illuminate different portions of the display screen.

Referring to FIG. 2B, in one embodiment, system 200 optionally includes a first light guide 212 and a second light guide 214. First light guide 212 may be configured to transmit light emanating from first light source 204 to first region 208 of display screen 202, and second light guide 214 may be configured to transmit light emanating from second light source 206 to second region 210. First light source 204 and second light source 214 may be a single light source, with separate light shutters for controlling the provision of light to, through, or from first light guide 212 and second light guide 214. The light guides may be made of any material suitable for conducting light in a particular display system application, as will be understood by one of skill in the art. It will be understood that alternative techniques for delivering light from the light sources to display screen 202 may be utilized, including, but not limited to, LED and plasma displays having independently illuminated picture elements.

Still referring to FIG. 2B, in one embodiment, system 200 optionally includes a light barrier 216 that substantially blocks light emanating from first light source 204 from leaking into second region 210, and also substantially blocks light emanating from second light source 206 from leaking into first region 208. Light barrier 216 may, for example, be manufactured using an opaque or reflective material. Light barrier 216 may be disposed between first light guide 212 and second light guide 214 such that light cannot travel between the light guides, or in any other configuration that substantially prevents light from leaking across a boundary 218 between first region 208 and second region 210 of display screen 202. In yet another embodiment, first light guide 212 and second light guide 214 may be formed from a single piece of material, and light barrier 216 is an etching across a surface of the material, such as a laser scribe, that effectively blocks light from traveling between first light guide 212 and second light guide 214. It will be understood that where the first light source 204 and/or second light source 206 are backlight units, the use of one or more light guides may be omitted.

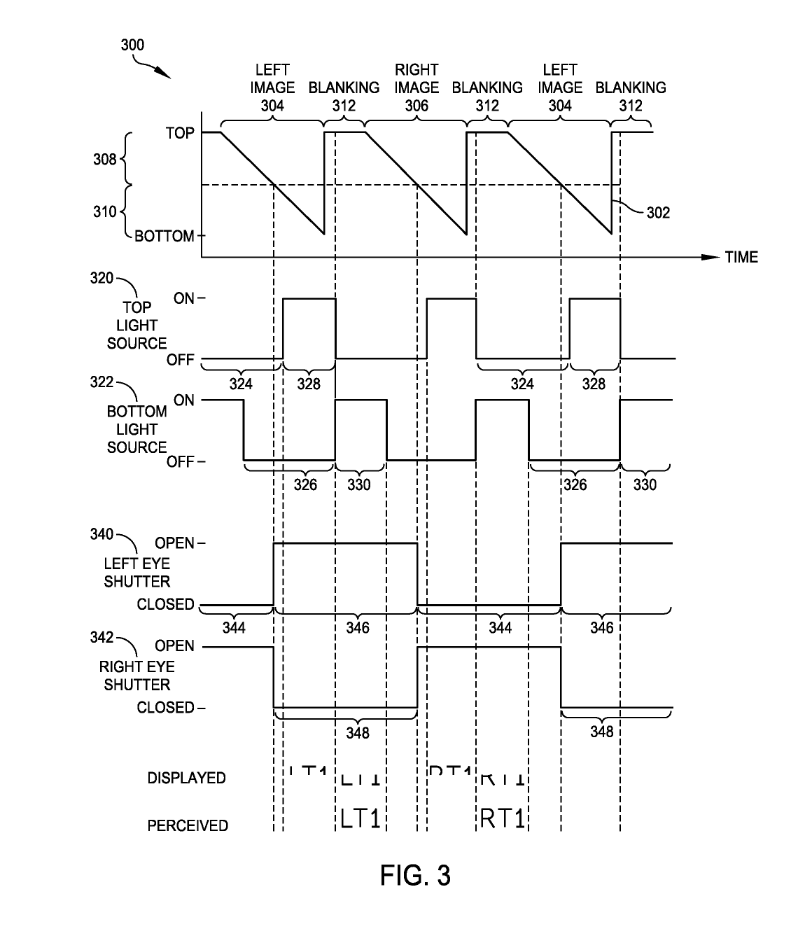

FIG. 3 is a timing diagram illustrating a sequence of events 300 that occur while displaying of series of stereoscopic images in accordance with one embodiment of the invention. A display device, such as a television having a display screen, updates each image in a raster or other sequential scanning pattern across the screen, for example, from the top of the screen to the bottom of the screen, one row at a time, which is illustrated by sequence 302. Sequence 302 further illustrates presenting the series of stereoscopic images in an alternating frame sequence, for example, a left eye field of view image 304 followed by a right eye field of view image 306. The display screen is partitioned into two regions approximating the top half 308 and bottom half 310 of the display screen, respectively. Accordingly, during each image update, the top region 308 is updated before the bottom region 310. After the bottom region 310 has been updated, there may optionally be a blanking interval 312, during which no update occurs. Sequence 302 repeats indefinitely as each image in the series of images is sequentially displayed.

According to one embodiment, the display screen is illuminated by at least two light sources, for example, a top light source 320 and a bottom light source 322. Top light source 320 and bottom light source 322 may each comprise one or more individual light sources, such as fluorescent lamps or other light emitters (e.g., light emitting diodes). The top light source 320 is configured to illuminate substantially the top region 308 of the display, and the bottom light source 322 is configured to illuminate substantially the bottom region 310 of the display, such as described above with reference to FIGS. 2A and 2B. Each of the light sources is controlled in synchronization with the update each image, as illustrated by sequence 302. While the top region 308 is being updated with a first portion of the left image 304, the top light source 320 is dimmed, lessened or turned off during a first region update time period 324. This obscures the portion of the left image 304 that is within the top region 308 from being observed by the viewer. Next, while the bottom region 310 is being updated with a second portion of the left image 304, the bottom light source 322 is dimmed, lessened or turned off during a second region update time period 326, to obscure the portion of the left image 304 within the bottom region 310 from the viewer. Meanwhile, after the top region 308 has been updated with the first portion of the left image 304, the top light source 320 is illuminated or turned on during a first region display period 328. This enables the first portion of the left image 304 to be observed by the viewer. Similarly, after the bottom region 310 has been updated with the second portion of the left image 304, the bottom light source 322 is illuminated or turned on during a second region display period 330, to enable the second portion of the left image 304 to be observed.

First region update time period 324 may end, and first region display period 328 may begin, substantially simultaneously to the completion of the update of the top region 308, or after the update of the top region 308 has completed. Further, second region update time period 326 may end, and second region display period 330 may begin, substantially simultaneously to the completion of the update of the bottom region 310, or after the update of the bottom region 310 has completed. Each of these time periods may be adjusted to account for variances in the update rate of the display screen and/or the latent on-off transition times of the top light source 320 and bottom light source 322. Yet further, at least a portion of first region display period 328 and second region display period 330 may coincide with the blanking interval 312. In a preferred embodiment, first region display period 328 and second region display period 330 are of substantially the same duration. The sequence described above with respect to an update of the left image 304 is repeated for an update of the right image 306, as shown in FIG. 3.

Still referring to FIG. 3, according to another embodiment, the series of stereoscopic images is observed by a viewer wearing shutter glasses having two independently controllable shutter lenses, a left lens 340 and a right lens 342. Each lens may be open (e.g., “unblocked”) or closed (e.g., “blocked”) to allow light to pass through the lens, or to block light, respectively. In this manner, the display device controls which of the viewer's eyes can see the image depending on which field of view is currently displayed on the display screen. For example, while the top region 308 is being updated with a first portion of the left image 304, the left lens 340 may be closed during left eye blocking period 344. This obscures any portion of the displayed image from being observed by the viewer's left eye. Next, while the bottom region 310 is being updated with a second portion of the left image 304, the left lens 340 may be opened during left eye unblocking period 346 to permit observation of the first portion of the left image 304. Further, while the top region 308 is being updated with a first portion of the right image 306, the left lens 340 may remain open to permit observation of the second portion of the left image 304. The right lens 342 may be closed during a right eye blocking period 348 while the left lens 340 is open to prevent the viewer from observing any portion of the left image 304 while it is displayed. The sequence described above with respect to the left image 304 is repeated for the right image 306, as illustrated in FIG. 3, except that the right lens 342 may be open and the left lens 340 may be closed to permit the viewer to observe the right image 306 with the right eye only.

In another embodiment, the left lens 340 is controlled in combination with the top light source 320 and bottom light source 322, to permit the viewer to observe only the top region 308 of the display screen, the bottom region 310 of the display screen, or both while the left lens 340 is open and while the left image 304 is displayed. The right lens 342 is similarly controlled while the right image 306 is displayed, as illustrated in FIG. 3.

FIG. 4 is a flow chart illustrating a method of displaying a stereoscopic image 400 according to one embodiment. Method 400 may be implemented by a sequentially updatable display device such as described above with reference to FIG. 1, for example, a television that updates a display screen using a raster or other sequential scan technique. The display screen may be partitioned into two or more contiguous regions of substantially equal area, for example, a first region that includes the top half of the display screen, and a second region that includes the bottom half of the display screen.

Method 400 includes detecting an update of the first region of the display screen (ACT 402). While the first region is updating, a first portion of the image that is displayed within the first region is obscured from the viewer (ACT 404). The first portion of the image may be obscured by dimming or lessening a light source that illuminates the first region. The first portion of the image may, additionally or alternatively, be obscured by blocking one or both lenses of shutter glass eyewear worn by the viewer to prevent light from reaching the viewer's eye(s). Further, while the first region is updating, a second portion of the image that is displayed within the second region may be displayed to the viewer (ACT 406). In this manner, the viewer is permitted to see half of the screen, which may be the half that is not currently being updated, and may contain a portion of the previously presented image.

Method 400 further includes detecting an update of the second region of the display screen (ACT 408). This may occur after the first region has completed updating, for example, as would occur during a raster scan update of the display screen. While the second region is updating, a second portion of the image that is displayed within the second region is obscured from the viewer (ACT 410). The second portion of the image may be obscured by dimming or lessening a light source that illuminates the second region. The second portion of the image may, additionally or alternatively, be obscured by blocking one or both lenses of shutter glass eyewear worn by the viewer to prevent light from reaching the viewer's eye(s). Further, while the second region is updating, the first portion of the image that is displayed within the first region may be displayed to the viewer (ACT 412). Method 400 may repeat indefinitely for each image that is subsequently displayed.

In some stereoscopic display techniques, the display may be dimmed, or the light source lessened, during the entire image update to obscure the artifacts associated with image-to-image transitions during, for example, an alternate frame sequence. Therefore, the amount of time that the image is ultimately displayed is typically limited to the relatively short display idle time or blanking interval, when no update is occurring. At certain update rates this results in a diminished brightness of the display, and thus a faster update rate is required to preserve the integrity of the viewing experience at acceptable brightness levels. For example, at 240 Hz, fifty percent of the total image time may be dedicated to updating the display while it is dimmed or obscured, and the remaining fifty percent of the time may be used for illuminating the display so that the viewer can see the image, resulting in a fifty percent overall decrease in brightness compared with non-stereoscopic modes of operation. At 480 Hz, only 25% of the total image time may be required for updating the display, allowing 75% of the time for viewing and a lesser decrease in brightness. It is appreciated that updating the display at a rate of 240 Hz or greater provides a picture that is acceptable to many consumers; however, the cost of producing displays having higher update rates is greater than the cost of producing displays that operate at, for example, 120 Hz.

It should be appreciated that by partitioning the display into two or more regions, and illuminating only those regions that are not being updated, while dimming, or lessening the light level of the region that is undergoing an update, the brightness of, for example, a display operating at 120 Hz is the same as the brightness of a non-partitioned display operating at 240 Hz, such as described above. This is because there is always at least one region or another of the display that is illuminated for approximately the same amount of time at 120 Hz as in the non-partitioned 240 Hz unit. For example, in a 120 Hz unit having two display regions of substantially the same area (e.g., a top half and a bottom half), the total amount of time that each display region is illuminated separately is about the same as the total amount of time that the entire display is illuminated in a non-partitioned 240 Hz unit (e.g., 50% of the total image time, or more). Thus, according to various aspects of the present invention, the ability to provide a display for viewing stereoscopic images at a lower update rate, and lower cost, but having the same brightness characteristics of a higher speed display can be achieved. Further, a partitioned display operating at, for example, 240 Hz, in accordance with various aspects, can provide the same, increased brightness characteristics of a faster display, at relatively little additional cost with respect to the faster unit.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the scope of the invention. It should be appreciated that the video source may be projected in sequences other than an alternating-frame sequence, for example, with left and right fields of view projected simultaneously (or substantially simultaneously), or in a left-left-right-right sequence, or other combination of sequences. Furthermore, other techniques may be used to enhance the 3D effect of the displayed images, such as increasing the update rate of the display (e.g., 240 Hz or greater) and/or increasing the vertical blanking interval to enable the viewer to observe the image longer between image updates. Accordingly, the foregoing description and drawings are by way of example only.

What is claimed is:

1. An electronic visual display system, comprising:
a display screen for displaying an image, the display screen having at least a first display region and at least a second display region that is approximately contiguous to the first display region, the image having at least a first portion to be displayed within the first display region and at least a second portion to be displayed within the second display region;
a first light source configured to illuminate substantially the first display region;
a second light source configured to illuminate substantially the second display region; and
a display device controller coupled to the first light source and the second light source, the display device controller configured to lessen an amount of light emanating from the first light source approximately when updating of the first portion of the image.

2. The system of claim 1, wherein the display device controller is further configured to lessen an amount of light emanating from the second light source approximately when updating of the second portion of the image.

3. The system of claim 2, wherein the display device controller is further configured to increase the amount of light emanating from the first light source subsequent to updating the first portion of the image, and further configured to increase the amount of light emanating from the second light source subsequent to updating the second portion of the image.

4. The system of claim 3, further comprising a first light guide configured to transmit the amount of light emanating from the first light source to the first display region, and a second light guide configured to transmit the amount of light emanating from the second light source to the second display region.

5. The system of claim 4, wherein the second light source is the same as the first light source, and wherein the system further comprises a first light shutter configured to control the amount of light transmitted by the first light guide and a second light shutter configured to control the amount of light transmitted by the second light guide.

6. The system of claim 4, further comprising a light barrier disposed between the first light guide and the second light guide.

7. The system of claim 4, further comprising eyewear having a first shutter lens and a second shutter lens each coupled to the display device controller and each independently controllable by the display device controller in synchronization with updating the first portion of the image and updating the second portion of the image, respectively.

8. The system of claim 7, wherein the image comprises one of a left image and a right image, and wherein the display device controller is further configured to unblock the first shutter lens while at least one of the first portion of the left image and the second portion of the left image is displayed, and to unblock the second shutter lens while at least one of the first portion of the right image and the second portion of the right image is displayed.

9. The system of claim 3, wherein the first light source includes a first plurality of light emitting diodes, and wherein the second light source includes a second plurality of light emitting diodes.

10. The system of claim 2, further comprising eyewear having a first shutter lens and a second shutter lens each coupled to the display device controller and each independently controllable by the display device controller in synchronization with updating the first portion of the image and updating the second portion of the image, respectively.

11. The system of claim 10, wherein the image comprises one of a left image and a right image, and wherein the display device controller is further configured to unblock the first shutter lens while at least one of the first portion of the left image and the second portion of the left image is displayed, and to unblock the second shutter lens while at least one of the first portion of the right image and the second portion of the right image is displayed.

12. The system of claim 11, wherein the display device controller is further configured to block the first shutter lens while the at least one of the first portion of the right image and the second portion of the right image is displayed, and to block the second shutter lens while the at least one of the first portion of the left image and the second portion of the left image is displayed.

13. The system of claim 1, wherein the first display region and the second display region have substantially equal areas.

14. The system of claim 13, wherein the first display region includes a top half of the display screen and the second display region includes a bottom half of the display screen.

15. The system of claim 13, wherein the first display region includes a left half of the display screen and the second display region includes a right half of the display screen.

16. A method of displaying an image on a display screen, the method comprising acts of:
detecting an update of a first portion of the image;
obscuring the first portion of the image responsive to detecting the update of the first portion of the image; and
displaying a second portion of the image during the act of obscuring the first portion of the image.

17. The method of claim 16, further comprising detecting an update of the second portion of the image, obscuring the second portion of the image responsive to detecting the update of the second portion of the image, and displaying the first portion of the image during the act of obscuring the second portion of the image.

18. The method of claim 17, wherein obscuring the first portion of the image includes lessening a first amount of light provided to illuminate substantially a first region of the display screen, and wherein obscuring the second portion of the image includes lessening a second amount of light provided to illuminate substantially a second region of the display screen.

19. The method of claim 18, wherein displaying the first portion of the image includes increasing the first amount of light, and wherein displaying the second portion of the image includes increasing the second amount of light.

20. The method of claim 19, wherein obscuring the first portion of the image further includes blocking the first amount of light with at least one lens of eyewear, and wherein obscuring the second portion of the image further includes blocking the second amount of light with the at least one lens of the eyewear.

21. The method of claim 20, wherein displaying the first portion of the image further includes unblocking the first amount of light with the at least one lens of the eyewear, and wherein displaying the second portion of the image further includes unblocking the second amount of light with the at least one lens of the eyewear.

22. The method of claim 17, wherein obscuring the first portion of the image further includes blocking a first amount of light provided to illuminate substantially a first region of the display screen with at least one lens of eyewear, and wherein obscuring the second portion of the image further includes blocking a second amount of light provided to illuminate substantially a second region of the display screen with the at least one lens of the eyewear.

23. The method of claim 16, wherein the first portion of the image comprises at least a portion of one of a left eye field of view and a right eye field of view, and wherein the second portion of the image comprises at least a different portion of one of the left eye field of view and the right eye field of view.
